(19) United States
(12) Patent Application Publication
(10) Pub. No.: US 2002/0114663 A1
(43) Pub. Date: Aug. 22, 2002

(54) Trunk element connecting structure for an artificial christmas tree

(76) Inventor: Yin-Su Chung, Yun Lin Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/788,446

(22) Filed: Feb. 21, 2001

(51) Int. Cl. F16D 1/00; B25G 3/00

(52) U.S. Cl. 403/300

(57) ABSTRACT

A trunk element connecting structure for artificial Christmas tree, includes a first trunk element, a second trunk element, a coupling plate fastened to one end of the first trunk element, and a connecting plate fastened to one end of the second trunk element and coupled to the coupling plate through a rotary motion to secure the first trunk element and the second trunk element longitudinally in a line.

### BACKGROUND OF THE INVENTION

The present invention relates to artificial Christmas tree and, more specifically, to a trunk element connecting structure for an artificial Christmas tree.

Regular trunks for artificial Christmas trees include two types, namely, the wooden trunks and the metal trunks. A wooden trunk for artificial Christmas tree may be comprised of two or more trunk elements connected in a line. FIG. 1 shows a wooden trunk element connecting structure for this purpose. As illustrated, the wooden trunk elements 1 and 2 each has a plurality of pin holes 1a or 2a at one end, and equal number of locating pins 3 are fastened to the pin holes 1a and 2a to secure the trunk elements 1 and 2 together. This trunk element connecting structure has drawbacks as outlined hereinafter.

1. When the artificial Christmas tree is shaken by wind or an external force, a pressure is given to the trunk elements 1 and 2 against the locating pins 3, thereby causing the locating pins 3 to damage the periphery of the pin holes 1a and 2a. In order to eliminate this problem, external fastening means may be fastened to the connecting area between the trunk elements 1 and 2. However, the installation of the external fastening means destroys the sense of beauty of the trunk thus obtained.

2. In case the pin holes 1a and 2a are not accurately made on the trunk elements 1 and 2, the periphery of the trunk elements 1 and 2 cannot be maintained in flush after the trunk elements 1 and 2 had been connected in a line.

### SUMMARY OF THE INVENTION

The present invention has been accomplished to provide a trunk element connecting structure, which eliminates the aforesaid drawbacks. It is one object of the present invention to provide a trunk element connecting structure, which enables two trunk elements to be easily and positively connected in a line to form a trunk or a part of a trunk for an artificial Christmas tree. It is another object of the present invention to provide a trunk element connecting structure, which keeps the trunk elements peripherally in flush when assembled. According to one aspect of the present invention, the trunk element connecting structure comprises a first trunk element, a second trunk element, a coupling plate fastened to one end of the first trunk element, and a connecting plate fastened to one end of the second trunk element and coupled to the coupling plate through a rotary motion to secure the first trunk element and the second trunk element longitudinally in a line. According to another aspect of the present invention, the coupling plate comprises at least one locating flange, the connecting plate comprises at least one engagement flange respectively forced into engagement with the at least one locating flange of the coupling plate through a rotary motion.

### BRIEF DESCRIPTION OF THE DRAWINGS

FIG. 1 is an exploded view of a trunk element connecting structure according to the prior art.

FIG. 2 is an exploded view of a trunk element connecting structure according to the present invention.

FIG. 3 is a schematic drawing showing the assembly process of the present invention.

FIG. 4 is a top plain view of the present invention, showing the connecting plate attached to the coupling plate before engagement.

FIG. 5 is a sectional view taken along line 5-5 of FIG. 4.

FIG. 6 is a top plain view showing the connecting plate engaged with the coupling plate according to the present invention.

FIG. 7 is a sectional view taken along line 7-7 of FIG. 6.

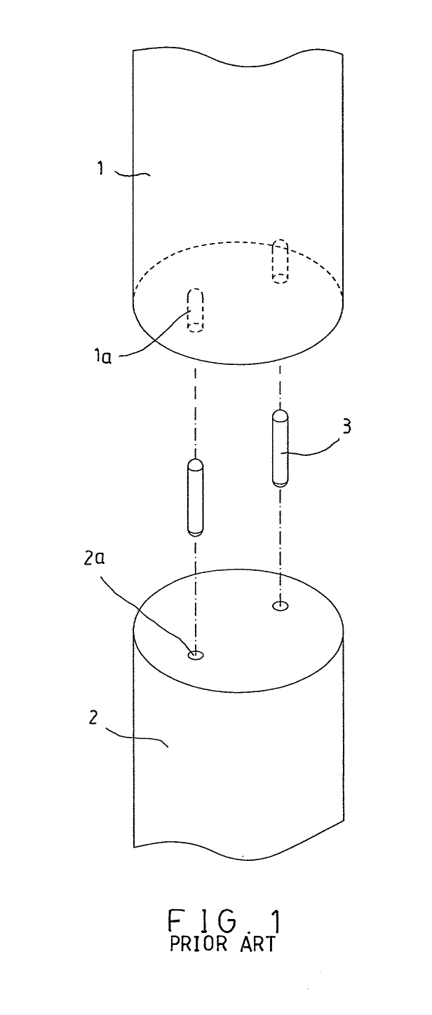

### DETAILED DESCRIPTION OF THE PREFERRED EMBODIMENT

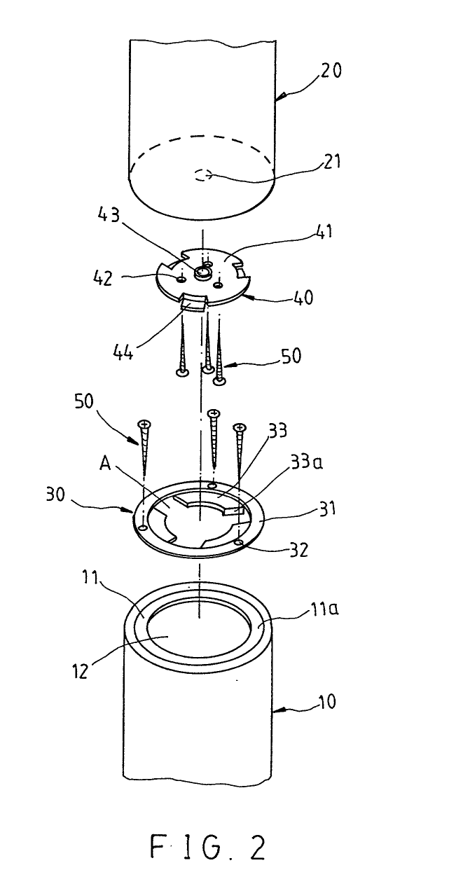

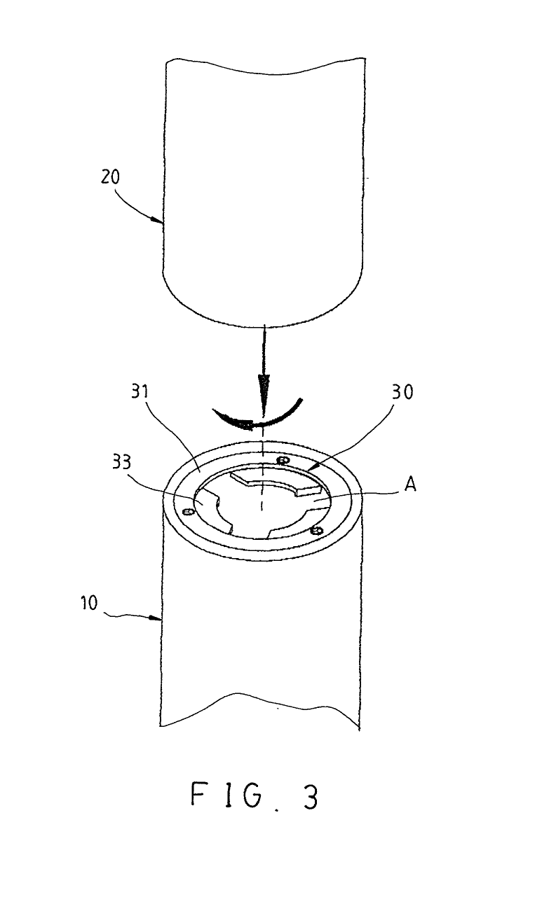

Referring to FIGS. 2 and 3, a trunk element connecting structure for an artificial Christmas tree in accordance with the present invention is generally comprised of a first trunk element 10, a second trunk element 20, a coupling plate 30, and a connecting plate 40.

The trunk elements 10 and 20 are cylindrical elements made of wood, having same outer diameter. The trunk elements 10 and 20 are longitudinally connected in line, forming a trunk for an artificial Christmas tree. The first trunk element 10 comprises a first countersunk hole 11 disposed at the top end edge thereof, a second countersunk hole 12 concentrically disposed within the first countersunk hole 11, i.e., the diameter of the first countersunk hole 11 is smaller than the outer diameter of the first trunk element 10 but greater than the diameter of the second countersunk hole 11 and, the first countersunk hole 11 defines with the second countersunk hole 12 an annular step 11a. The second trunk element 20 has a positioning hole 21 at the center of the bottom end edge thereof.

The coupling plate 30 is a flat, circular metal member comprising an annular base 31 fitting the first countersunk hole 11 of the first trunk element 10 for enabling the coupling plate 30 to be received in the first countersunk hole 11 with the annular base 31 supported on the annular step 11a, three mounting through holes 32 equiangularly spaced on the annular base 31 through which screw nails 50 are respectively driven into the top end edge of the first trunk element 10 to fixedly secure the coupling plate 30 to the first trunk element 10, and three smoothly arched locating flanges 33 formed integral with and equiangularly spaced from one another by gaps A around the inner diameter of the annular base 31. The smoothly arched locating flanges 33 each have a protruded stop flange portion 33a downwardly disposed at one end.

The connecting plate 40 is a flat metal member comprising a disk-like base 41 of diameter slightly smaller than the inner diameter of the annular base 31 of the coupling plate 30, a stud 43 upwardly extended from the center of the top sidewall of the disk-like base 41 and press-fitted into the positioning hole 21 of the second trunk element 20, three mounting through holes 42 extended through the disk-like base 41 and equiangularly spaced around the stud 43 through which three screw nails 50 are driven into the bottom end edge of the second trunk element 20 to fixedly secure the connecting plate 40 to the second trunk element 20, and three L-shaped engagement flanges 44 equiangularly spaced around the periphery of the disk-like base 41. The width of the L-shaped engagement flanges 44 is slightly smaller than the gap A between each two adjacent locating flanges 33 of the coupling plate 30.

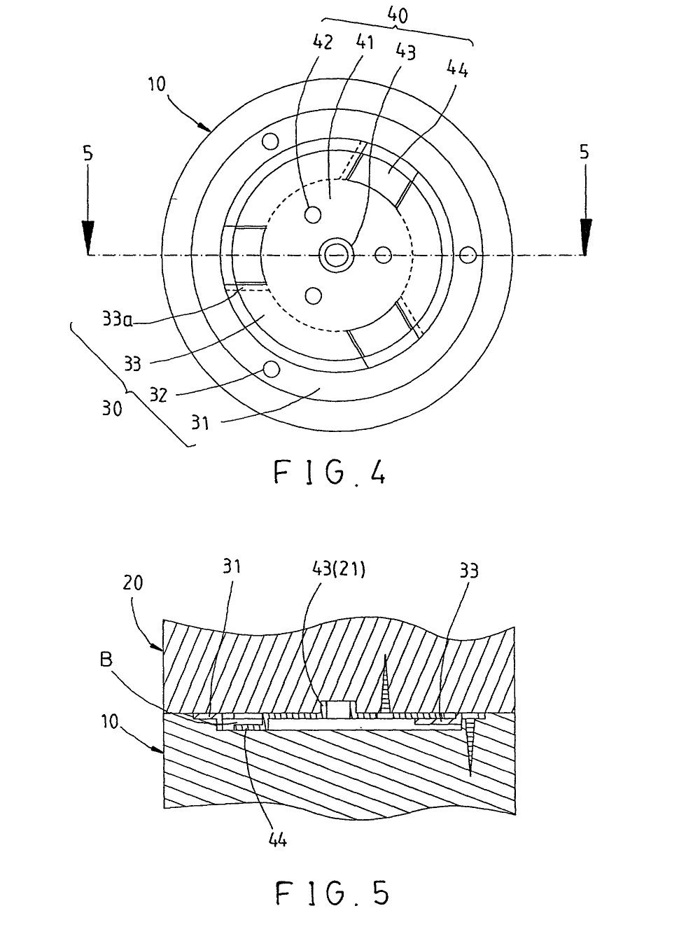

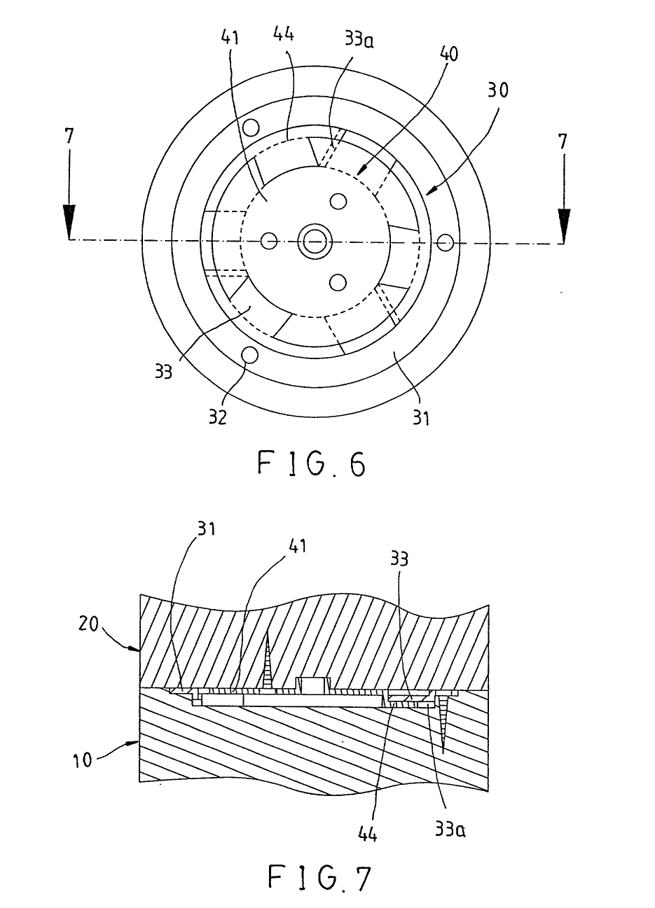

The use and advantages of the trunk element connecting structure are described hereinafter with reference to FIGS. from 3 through 7. When connecting the first trunk element 10 and the second trunk element 20, the first trunk element 10 and the second trunk element 20 are vertically aligned with the connecting plate 40 facing the coupling plate 30, and then the second trunk element 20 is abutted against the top end edge of the first trunk element 10 to force the L-shaped engagement flanges 44 of the connecting plate 40 into the gaps A between the locating flanges 33 of the coupling plate 30, for enabling the disk-like base 41 to be supported on the locating flanges 33 (see FIGS. 4 and 5), and then the first trunk element 10 and the second trunk element 20 are rotated through an angle relative to each other to force the locating flanges 33 of the coupling plate 30 into the gaps B defined between the L-shaped engagement flanges 44 and the disk-like base 41. At this time, the locating flanges 33 are clamped between the disk-like base 41 and the L-shaped engagement flanges 44. When continuously rotating the first trunk element 10 and the second trunk element 20 relatively to each other, the L-shaped engagement flanges 44 are respectively stopped at the protruded stop flange portions 33a of the locating flanges 33. Thus, the trunk element connecting structure is well assembled.

As indicated above, the invention concentrically respectively fasten two circular metal members to two trunk elements, and then couple the metal members together through a rotary motion, keeping the trunk elements longitudinally connected in a line. Because the metal members are kept from sight after the trunk elements have been connected in a line to form a trunk for an artificial Christmas tree, the trunk thus obtained has a good outlook.

While only one embodiment of the present invention has been shown and described, it will be understood that various modifications and changes could be made thereunto without departing from the spirit and scope of the invention disclosed.

What the invention claimed is:

1. A trunk element connecting structure for artificial Christmas tree, comprising a first trunk element, a second trunk element, a coupling plate fastened to one end of said first trunk element, and a connecting plate fastened to one end of said second trunk element and coupled to said coupling plate to secure said first trunk element and said second trunk element longitudinally in a line, said coupling plate comprising at least one locating flange, said connecting plate comprising at least one engagement flange respectively forced into engagement with said at least one locating flange of said coupling plate through a rotary motion.

2. The trunk element connecting structure of claim 1 wherein said first trunk element and said second trunk element are made of wood, and said coupling plate and said connecting plate are circular metal members respectively fixedly fastened to one end of said first trunk element and one end of said second trunk element.

3. The trunk element connecting structure of claim 2 wherein said coupling plate comprises an annular base and three locating flanges formed integral with and equiangularly spaced around an inner diameter of said annular base, and said connecting plate comprises a disk-like base and three stepped engagement flanges formed integral and equiangularly spaced around the periphery of said disk-like base and respectively forced into engagement with the locating flanges of said coupling plate.

4. The trunk element connecting structure of claim 1 of claim 1 wherein said at least one locating flange of said coupling plate each comprises a protruded stop flange portion downwardly disposed at one end and adapted to stop the at least one engagement flange of said connecting plate in place.
